(19) United States
(12) Patent Application Publication
(10) Pub. No.: US 2016/0366269 A1
(43) Pub. Date: Dec. 15, 2016

(54) APPARATUS AND METHOD OF MOBILE COMMUNICATION AND CONTENT SHARING

(71) Applicant: Mansour Hamdan MANSOUR, Amman (JO)

(72) Inventor: Mansour Hamdan MANSOUR, Amman (JO)

(21) Appl. No.: 15/181,953

(22) Filed: Jun. 14, 2016

Related U.S. Application Data
(60) Provisional application No. 62/175,726, filed on Jun. 15, 2015.

(51) Int. Cl. H04M 1/725; H04M 7/00; H04W 4/02

(52) U.S. Cl. CPC H04M 1/72563; H04M 1/72583; H04W 4/02; H04M 1/72544; H04M 7/006

(57) ABSTRACT

A method of communication between a sender's mobile communication device and a receiver's mobile communication device using a mobile app may comprise creating content on the sender's mobile communication device; sending the content to the receiver's mobile communication device; based upon the content being successfully sent to the receiver's mobile communication device, causing a dial icon to appear on the sender's mobile communication device; placing a voice call from the sender's mobile communication device to the receiver's mobile communication device by tapping the dial icon; and based upon the receiver's mobile communication device receiving the voice call, displaying the content on the receiver's mobile communication device for a predetermined duration or until the receiver answers the voice call. The content may also be displayed on the receiver's mobile communication device after the voice call has ended.

### PRIORITY

This application claims the benefit of U.S. Provisional Patent Application No. 62/175,726, entitled “New Mobile Social App Concept,” filed Jun. 15, 2015, the disclosure of which is incorporated by reference herein in its entirety.

### BACKGROUND

The present disclosure relates to mobile communications and content sharing. For example, some aspects of the present disclosure relate to the sharing of text, audio, visual, and/or other types of media before, during, and/or after making a voice call or voice over internet protocol (VoIP) call (hereinafter commonly referred to as a “voice call”) using a mobile communication device.

Many individuals utilize mobile communication devices to remain in contact with family, friends, business associates, etc. For example, a user of a wireless communication device may utilize voice calls, voice mail messages, email, Short Message Service (SMS) text messages, Instant Messaging (IM) applications, and other data services to stay in touch with various contacts.

In addition, some social networking systems, such as the websites Facebook (www.facebook.com) and Twitter (www.twitter.com), allow a user to stay in touch with a group of “friends” by sharing photos, videos, messages, posting status updates, etc. For example, if the user goes to a coffee shop, the user may connect to the social networking system and post a photo and a status update message that indicates the location of the coffee shop so that others may meet the user there if they are in the proximity.

Individuals are, however, continuously looking for other innovative ways to stay in touch with one another.

While a variety of mobile communications and content sharing systems and methods have been made and used, it is believed that no one prior to the inventors has made or used the systems and methods described herein.

### SUMMARY

According to an exemplary aspect of the present disclosure, a method of communication between a sender's mobile communication device and a receiver's mobile communication device using a mobile app may comprise: creating content on the sender's mobile communication device; sending the content to the receiver's mobile communication device; based upon the content being successfully sent to the receiver's mobile communication device, causing a dial icon to appear on the sender's mobile communication device; placing a voice call or voice over internet protocol (VoIP) call (hereinafter commonly referred to as a “voice call”) from the sender's mobile communication device to the receiver's mobile communication device by tapping the dial icon; and based upon the receiver's mobile communication device receiving the voice call, displaying the content on the receiver's mobile communication device for a predetermined duration or until the receiver answers the voice call.

In accordance with the above-described aspect of the present disclosure, the sender's mobile communication device and the receiver's mobile communication device may be connected to one another via one or more wireless communication networks. Further, the sender's mobile communication device and the receiver's mobile communication device may be connected to a backend via the one or more wireless communication networks.

In accordance with the above-described aspect of the present disclosure, the content may comprise at least one of the following parts: a photo, a video, an audio clip, a digital image or icon, sticker, emoji, a text message, a sketch or message, and a location of the sender or of the receiver.

In accordance with the above-described aspect of the present disclosure, the method may further comprise, based upon the content comprising a photo or a video, setting the photo or the video as a background of the content, otherwise setting a default background as the background of the content.

In accordance with the above-described aspect of the present disclosure, the method may further comprise, based upon the content comprising a digital image or icon, a text message, or a sketch or message, displaying the digital image or icon, sticker, emoji, the text message, or the sketch or message overtop the background.

In accordance with the above-described aspect of the present disclosure, the method may further comprise, based upon the content comprising a location of the sender or of the receiver, causing the backend to compute at least one of a distance and directions between the sender's location and the receiver's location. The content may comprise the distance and/or the directions.

In accordance with the above-described aspect of the present disclosure, the method may further comprise, displaying the content on the receiver's mobile communication device after the voice call has ended.

In accordance with the above-described aspect of the present disclosure, the method may further comprise, causing a floating icon to appear on the receiver's mobile communication device after the voice call has ended and displaying the content on the receiver's mobile communication device in response to the receiver tapping the floating icon.

In accordance with the above-described aspect of the present disclosure, the method may further comprise, prompting the sender to specify the area over which the floating icon is to be displayed on the receiver's mobile communication device.

In accordance with the above-described aspect of the present disclosure, the method may further comprise, determining at least one of whether the mobile app is installed on the receiver's mobile communication device and whether the receiver's mobile communication device is online.

In accordance with the above-described aspect of the present disclosure, the method may further comprise, blocking one or more contacts such that content is not received from the one or more contacts.

In accordance with the above-described aspect of the present disclosure, the method may further comprise, blocking one or more types of media such that the one or more types of media is not received.

According to an exemplary aspect of the present disclosure, a method of communication between a sender's mobile communication device and a receiver's mobile communication device using a mobile app may comprise: creating content on the sender's mobile communication device; sending the content to the receiver's mobile communication device; based upon the content being successfully sent to the receiver's mobile communication device, causing a dial icon to appear on the sender's mobile communication device; placing a voice call from the sender's mobile communication device to the receiver's mobile communication device by tapping the dial icon; and displaying the content on the receiver's mobile communication device before or after the voice call.

In accordance with the above-described aspect of the present disclosure, the sender's mobile communication device and the receiver's mobile communication device may be connected to one another via one or more wireless communication networks. Further, the sender's mobile communication device and the receiver's mobile communication device may be connected to a backend via the one or more wireless communication networks.

In accordance with the above-described aspect of the present disclosure, the method may further comprise, prompting the sender to specify whether the content is to be displayed on the receiver's mobile communication device before or after the voice call.

In accordance with the above-described aspect of the present disclosure, the method may further comprise, based upon the sender specifying that the content is to be displayed on the receiver's mobile communication after the voice call, causing a floating icon to appear on the receiver's mobile communication device after the voice call has ended and displaying the content on the receiver's mobile communication device in response to the receiver tapping the floating icon.

In accordance with the above-described aspect of the present disclosure, the method may further comprise, prompting the sender to specify the area over which the floating icon is to be displayed on the receiver's mobile communication device.

In accordance with the above-described aspect of the present disclosure, the content may comprise at least one of the following parts: a photo, a video, an audio clip, a digital image or icon, sticker, emoji, a text message, a sketch or message, and a location of the sender or of the receiver.

According to an exemplary aspect of the present disclosure, a method of communication between a sender's mobile communication device and a receiver's mobile communication device using a mobile app may comprise: creating content on the sender's mobile communication device; sending the content to the receiver's mobile communication device; based upon the content being successfully sent to the receiver's mobile communication device, causing a dial icon to appear on the sender's mobile communication device; placing a voice call from the sender's mobile communication device to the receiver's mobile communication device by tapping the dial icon; based upon the receiver's mobile communication device receiving the voice call, displaying the content on the receiver's mobile communication device for a predetermined duration or until the receiver answers the voice call; displaying the content on the receiver's mobile communication device after the voice call has ended.

In accordance with the above-described aspect of the present disclosure, the sender's mobile communication device and the receiver's mobile communication device may be connected to one another via one or more wireless communication networks. Further, the sender's mobile communication device and the receiver's mobile communication device may be connected to a backend via the one or more wireless communication networks.

In accordance with the above-described aspect of the present disclosure, the method may further comprise, causing a floating icon to appear on the receiver's mobile communication device after the voice call has ended and displaying the content on the receiver's mobile communication device in response to the receiver tapping the floating icon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

It is believed that the present disclosure will be better understood from the following description of certain examples taken in conjunction with the accompanying drawings, in which like reference numerals identify the same elements and in which:

FIG. 1 depicts a schematic view of an exemplary mobile app;

FIG. 2 depicts a schematic view of an exemplary backend;

FIG. 3 depicts a schematic view of a plurality of mobile communications devices, having the mobile app of FIG. 1, connected to one another and to the backend of FIG. 2 via one or more mobile communication networks;

FIG. 4A depicts a screenshot of an exemplary registration block of the mobile app of FIG. 1;

FIG. 4B depicts another screenshot of the registration block of FIG. 4A;

FIG. 5 depicts a screenshot of an exemplary verification block of the mobile app of FIG. 1;

FIG. 6 depicts a screenshot of an exemplary main screen of the mobile app of FIG. 1;

FIG. 7 depicts a screenshot of an exemplary camera(s) block of the mobile app of FIG. 1;

FIG. 8 depicts another screenshot of the camera(s) block of FIG. 7;

FIG. 9 depicts a screenshot of an exemplary microphone(s) block of the mobile app of FIG. 1;

FIG. 10 depicts a screenshot of an exemplary media library block of the mobile app of FIG. 1;

FIG. 11 depicts a screenshot of exemplary content to be sent via the mobile app of FIG. 1;

FIG. 12 depicts a screenshot of an exemplary text bubble and keyboard of the mobile app of FIG. 1;

FIG. 13 depicts another screenshot of the content to be sent of FIG. 11;

FIG. 14 depicts a screenshot of an exemplary sketch tool block of the mobile app of FIG. 1;

FIG. 15 depicts another screenshot of the content to be sent of FIG. 11;

FIG. 16 depicts a screenshot of an exemplary sketch-tool-specific settings block of the mobile app of FIG. 1;

FIG. 17 depicts a screenshot of an exemplary location reader block of the mobile app of FIG. 1;

FIG. 18A depicts a screenshot of an exemplary contacts block of the mobile app of FIG. 1;

FIG. 18B depicts another screenshot of the contacts block of FIG. 18A;

FIG. 19 depicts a screenshot of an exemplary invite block of the mobile app of FIG. 1;

FIG. 20 depicts a screenshot of an exemplary dial screen of the mobile app of FIG. 1;

FIG. 21 depicts a screenshot of a receiver's mobile communication device including a floating icon of the mobile app of FIG. 1;

FIG. 22 depicts a screenshot of exemplary content to be sent via the mobile app of FIG. 1, as shown on a receiver's mobile communication device while a voice call is pending;

FIG. 23 depicts a screenshot of exemplary content to be sent via the mobile app of FIG. 1, as shown on a receiver's mobile communication device while a voice call is pending;

FIG. 24 depicts a screenshot of exemplary content to be sent via the mobile app of FIG. 1, as shown on a receiver's mobile communication device while a voice call is pending;

FIG. 25 depicts a screenshot of exemplary content to be sent via the mobile app of FIG. 1, as shown on a receiver's mobile communication device while a voice call is pending;

FIG. 26 depicts a screenshot of exemplary content to be sent via the mobile app of FIG. 1, as shown on a receiver's mobile communication device while a voice call is pending;

FIG. 27 depicts a screenshot of exemplary content to be sent via the mobile app of FIG. 1, as shown on a receiver's mobile communication device while a voice call is pending;

FIG. 28 depicts a screenshot of an exemplary general settings block of the mobile app of FIG. 1;

FIG. 29 depicts a screenshot of an exemplary privacy portion of the general settings block of FIG. 28;

FIG. 30A depicts another screenshot of the privacy portion of FIG. 29;

FIG. 30B depicts another screenshot of the privacy portion of FIG. 29;

FIG. 31 depicts a screenshot of an exemplary profile block of the mobile app of FIG. 1;

FIG. 32 depicts a screenshot of an exemplary interests portion of the profile block of FIG. 31; and

FIG. 33 depicts a screenshot of an exemplary status screen.

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification merely illustrate several aspects of the present disclosure, and together with the description serve merely to explain principles of the present disclosure; it being understood, however, that the present disclosure is not limited to the precise arrangements depicted therein.

### DETAILED DESCRIPTION

The following description of certain examples of the present disclosure should not be used to limit its scope. Other examples, features, aspects, embodiments, and advantages of the present disclosure will become apparent to those skilled in the art from the following description, which is by way of illustration, one of the best modes contemplated for carrying out the present disclosure. As will be realized, the systems and methods described herein are capable of other different and obvious aspects, all without departing from the present disclosure. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

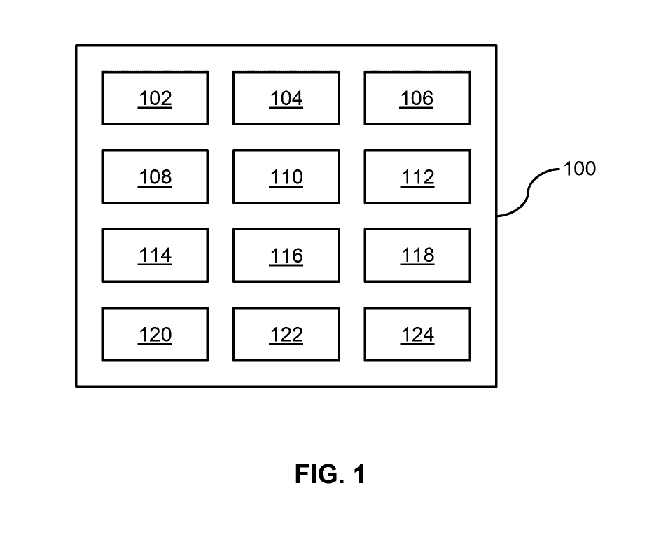

FIG. 1 schematically depicts an exemplary mobile app 100 (hereinafter also referred to as “Groolchat”). The mobile app 100 may be downloaded and installed on a user's mobile communication device 10 (e.g., a smartphone, tablet, etc.). As will be described in more detail below, the user (also hereinafter referred to as a “sender”) may interact with the mobile app 100 to initiate/achieve a multitude of functions (a portion of which are hereinafter referred to as “blocks”) using the hardware and/or software of the user's mobile communication device 10 and/or of a receivers mobile communication device 10A. The mobile app 100 includes a registration block 102, a verification block 104, a user profile block 106, a sketch tool block 108, a settings block 110, a contacts block 112, an invite block 114, a location reader block 116, a camera(s) block 118, a microphone(s) block 120, a media library block 122, and a floating widow block 124.

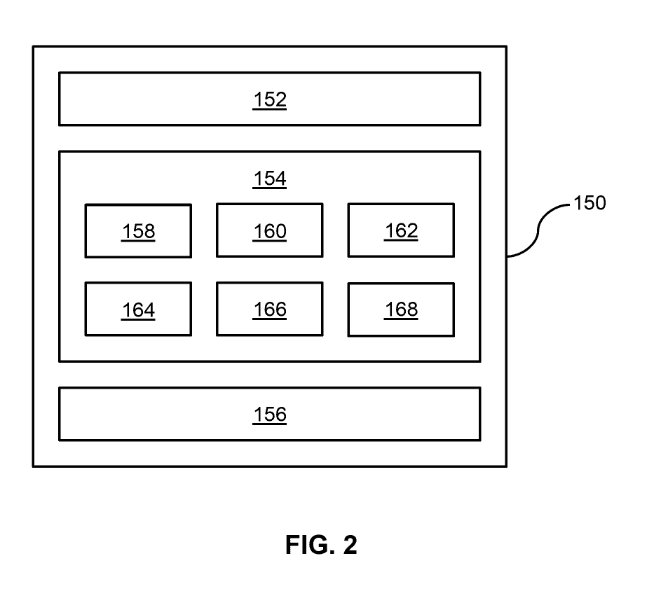

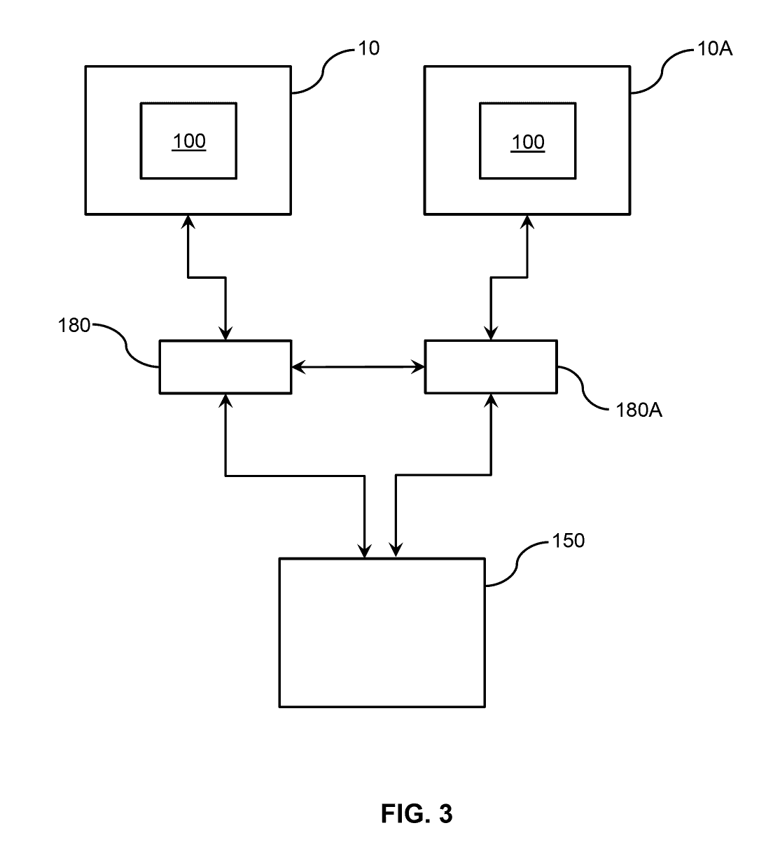

FIG. 2 schematically depicts a backend 150 that supports operation of the mobile app 100. As shown in FIG. 3, the mobile app 100 and the backend 150 communicate via a wireless communication network 180 such as the Internet, LTE, satellite, etc. The backend 150 includes a web server 152, a database 154, and a notification server 156. As will be described in more detail below, the database 154 performs a multitude of functions (a portion of which are hereinafter referred to as “blocks”). The database 154 includes a profile management block 158, a media management block 160, a contacts management block 162, a sticker and emoji management block 164, a notification management block 166, and a blocking management block 168.

The mobile app 100 may be downloaded on the user's mobile communication device 10 which, as described above, is connected with the backend 150 via the wireless communication network 180. In addition, other users (also hereinafter referred to as “receivers”) may download the mobile app 100 on their respective mobile communication devices 10A which are connected with the backend 150 via a wireless communication network 180A as shown in FIG. 3. (It should be appreciated that the wireless communication network 180A may be the same or a different wireless communication network as the wireless communication network 180.) Furthermore, the user's mobile communication device 10 may be connected with the other users' respective mobile communication devices 10A via the wireless communication networks 180, 180A or any another wireless communication network.

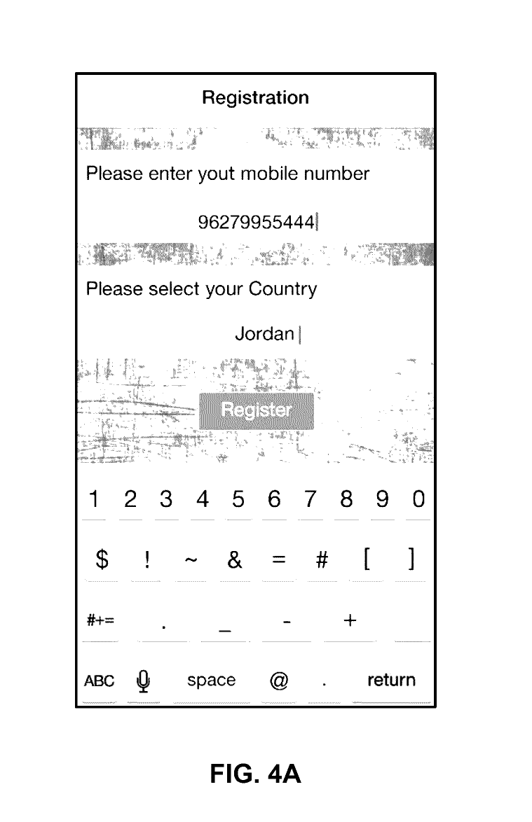

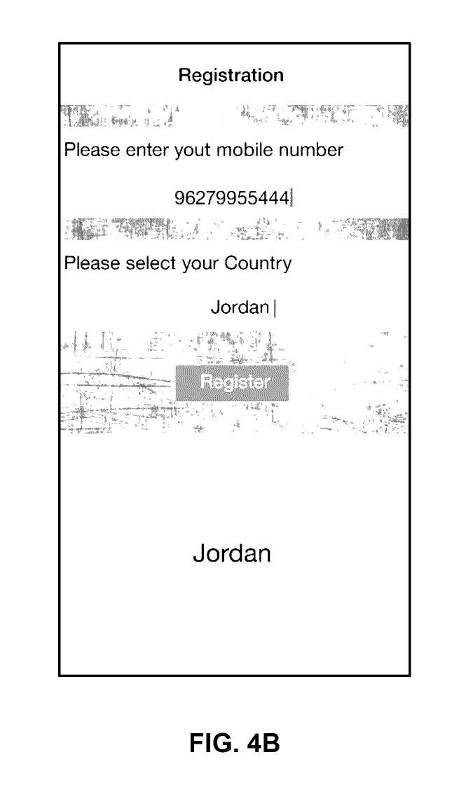

After the mobile app 100 is downloaded and installed on the user's mobile communication device 10, the registration block 102 of the mobile app 100 may automatically or manually register the user's mobile communication device 10. For example, as shown in FIGS. 4A and 4B, the mobile app 100 may prompt the user to enter his or her phone number and country of origin. The mobile app 100 may then send the user's phone number to the backend 150 which in turn sends a verification SMS text message to the user's mobile communication device 10 to thereby complete registration.

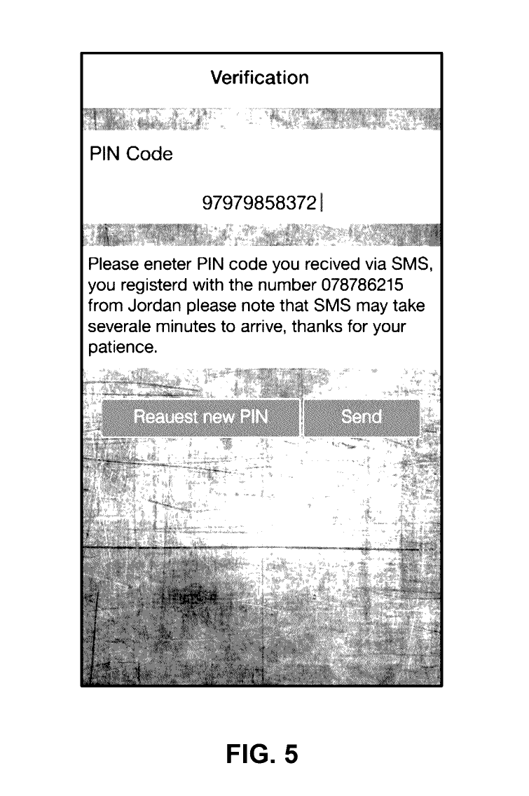

As shown in FIG. 5, during installation of the mobile app 100, the user may be required to provide a unique pin number which is in turn stored in the backend 150 and which is associated with the user's mobile communication device 10. Alternatively, a unique pin code may be generated and provided by the backend 150 with the verification SMS text message. In this manner, when the user opens the mobile app 100, the verification block 104 may require the user to enter the unique pin code to prevent unpermitted or unintended use of the mobile app 100.

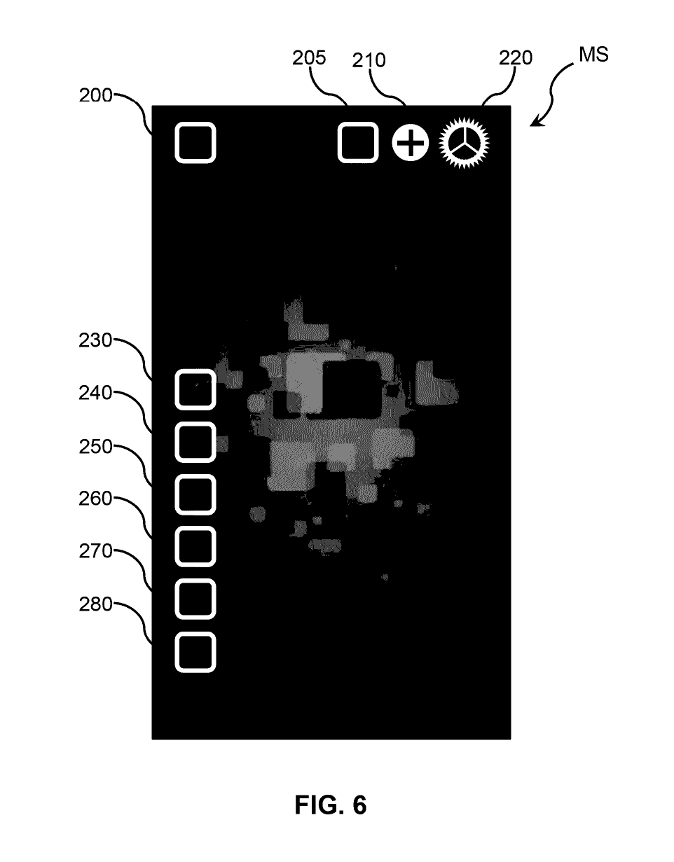

After verification by the verification block 104, the user is directed to a main screen MS. As shown in FIG. 6, the main screen MS includes a plurality of buttons which permit the user to initiate/achieve the functions of the mobile app 100. The main screen MS includes a contacts button 200, a status button 205, an invite button 210, a settings button 220, a camera button 230, a speaker button 240, a sticker library button 250, a text button 260, a sketch button 270, and a location button 280.

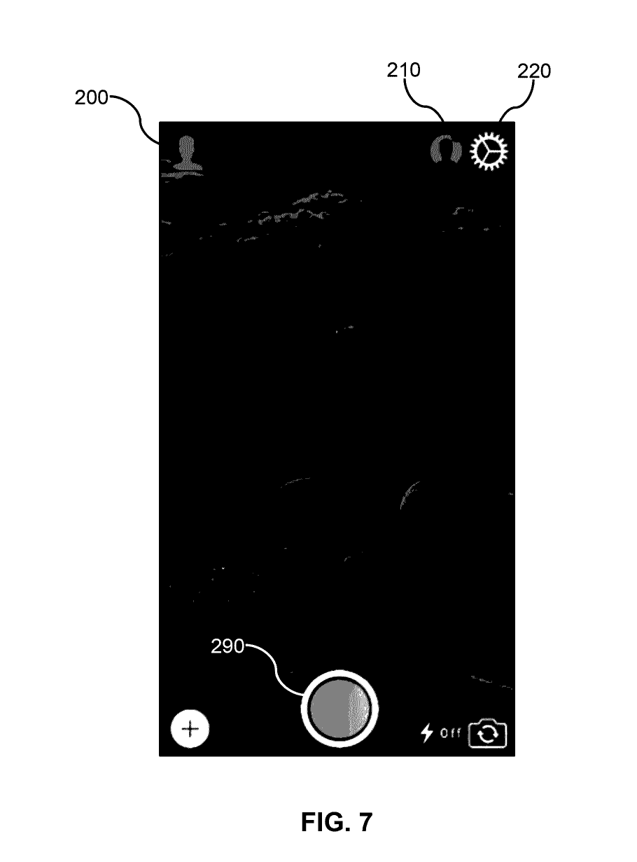

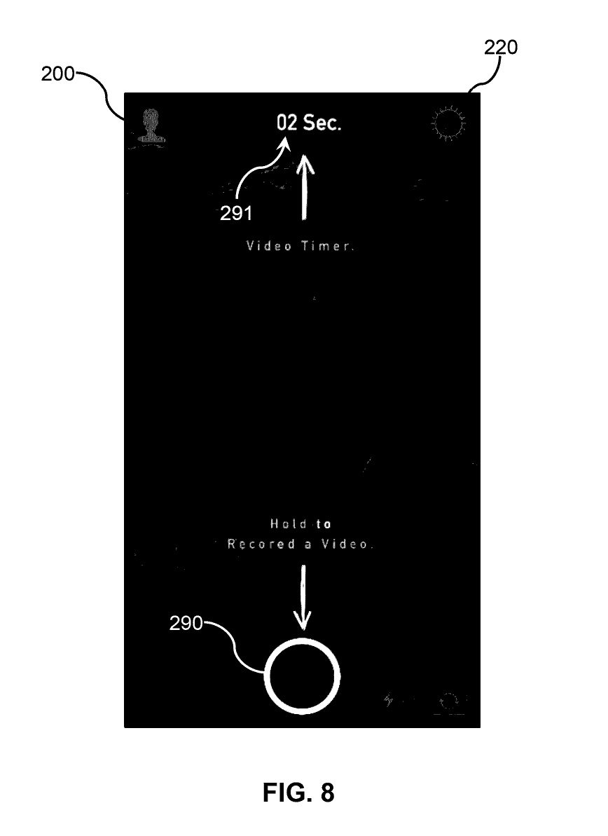

From the main screen MS, the user may create content to be sent (hereinafter also referred to merely as “content” or “Grool”). For example, by tapping the camera button 230, the user initiates use of the camera(s) of the user's mobile communication device 10 (camera(s) block 118). As shown in FIG. 7, when using the camera, an image being captured by the camera is depicted on the screen of the user's mobile communication device 10 in real-time. Furthermore, when using the camera, a shutter button 290, a flash button, and a flip camera button appear on the screen. By tapping the shutter button 290, the user may take a photo as one part of the content to be sent. Alternatively, as shown in FIG. 8, by holding the shutter button 290, the user may create a video as one part of the content to be sent. When creating a video, a video timer 291 may appear on the screen. As opposed to creating his or her own photo or video, the user may choose to use an existing photo or video or portion thereof as one part of the content to be sent. The existing photo or video may be one created by the user and stored on the user's mobile communication device 10 or may be one created by a third-party and stored in the backend 150. The existing photo or video may be accessed by tapping a media library button on the screen of the mobile app 100.

The photo or video, when included as part of the content to be sent, may be set as a background for the content to be sent. However, the user may choose not to include a photo or video as one part of the content to be sent, in which case the mobile app 100 will provide a default background. For example, the mobile app 100 may use a blank, colored, or patterned background as a default background.

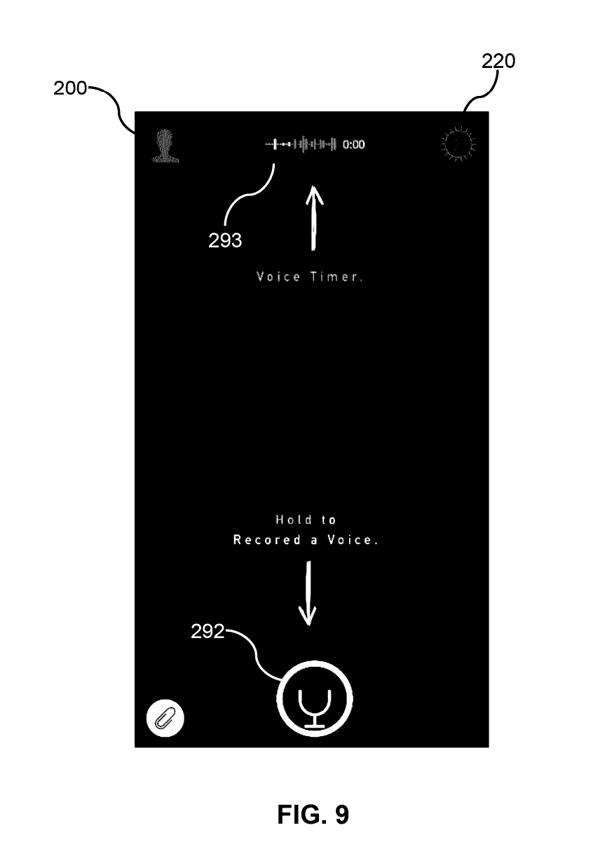

By tapping the speaker button 240, the user initiates use of the microphone(s) of the user's mobile communication device 10 (microphone(s) block 120). As shown in FIG. 9, when using the microphone, a record button 292 and a voice timer 293 appear on the screen of the user's mobile communication device 10. By holding the record button 292, the user may record an audio clip as one part of the content to be sent. Alternatively, the user may choose to use an existing audio clip or portion thereof as one part of the content to be sent. The existing audio clip may be accessed by tapping a media library button on the screen of the mobile app 100. he existing audio clip may be one created by the user and stored on the user's mobile communication device 10 or may be one created by a third-party and stored in the backend 150.

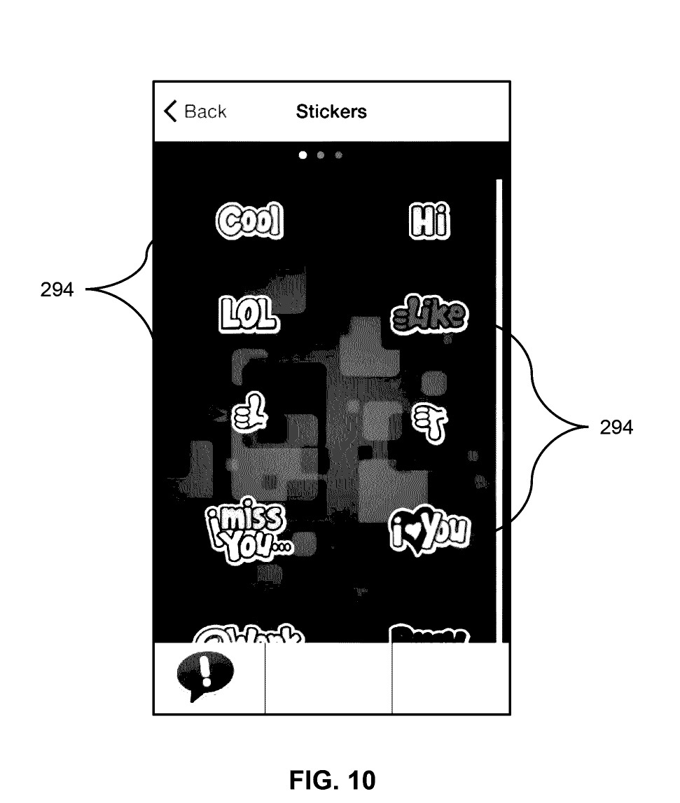

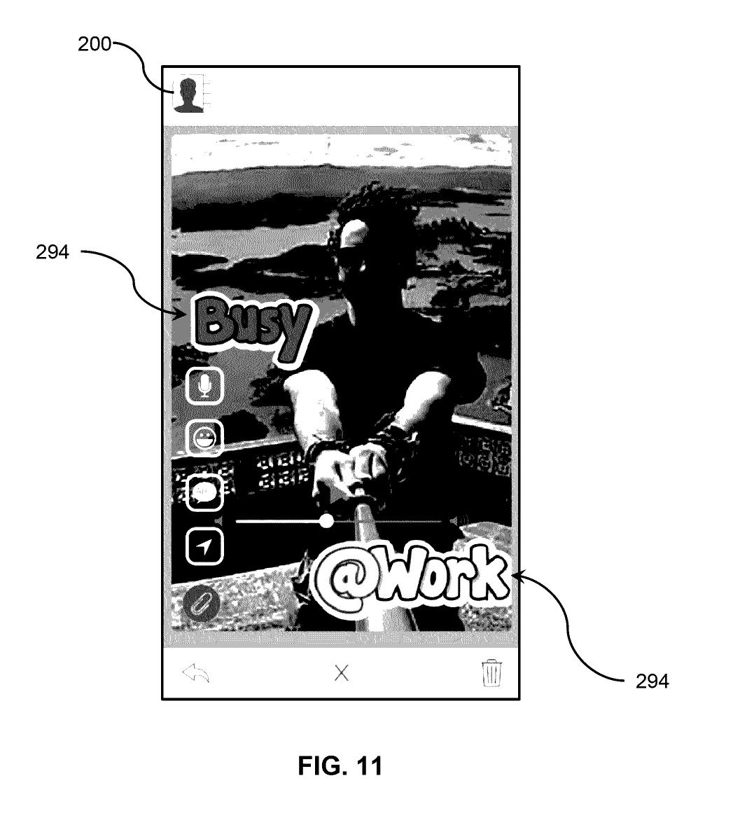

By tapping the sticker button 250, the user accesses a media library stored on the user's mobile communication device 10 and/or in the backend 150 (media library block 122, sticker and emoji management block 164). As shown in FIG. 10, the media library includes digital images or icons 294 such as stickers, emojis, clipart, etc. displayed as a scrollable list. The user may choose one or more images or icons 294 from the list to include as one part of the content to be sent. As shown in FIG. 11, the one or more images or icons 294 may be displayed overtop the background (i.e., overtop the photo, the video, the default background, etc.) or may alternatively be sent alone. The user may position the images or icons 294 by dragging and dropping the image or icon 294 at a particular location on the background.

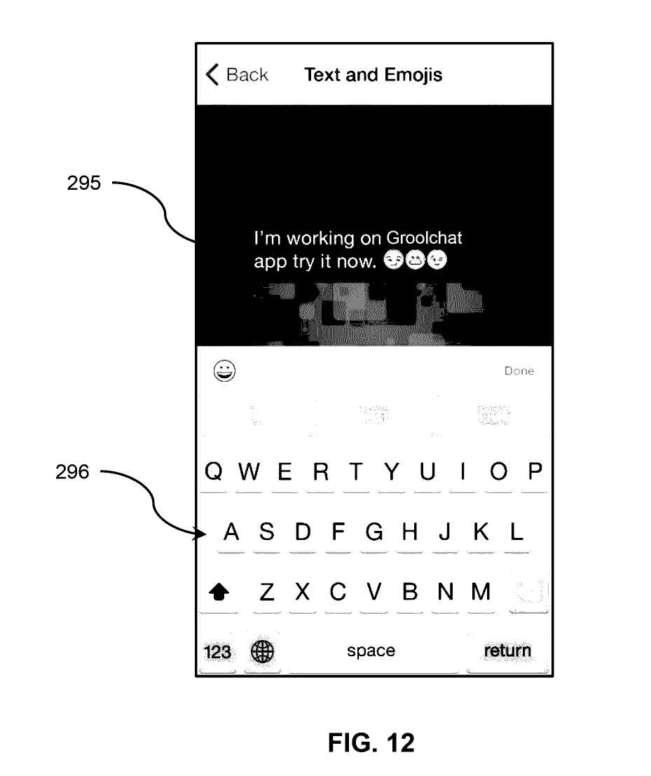

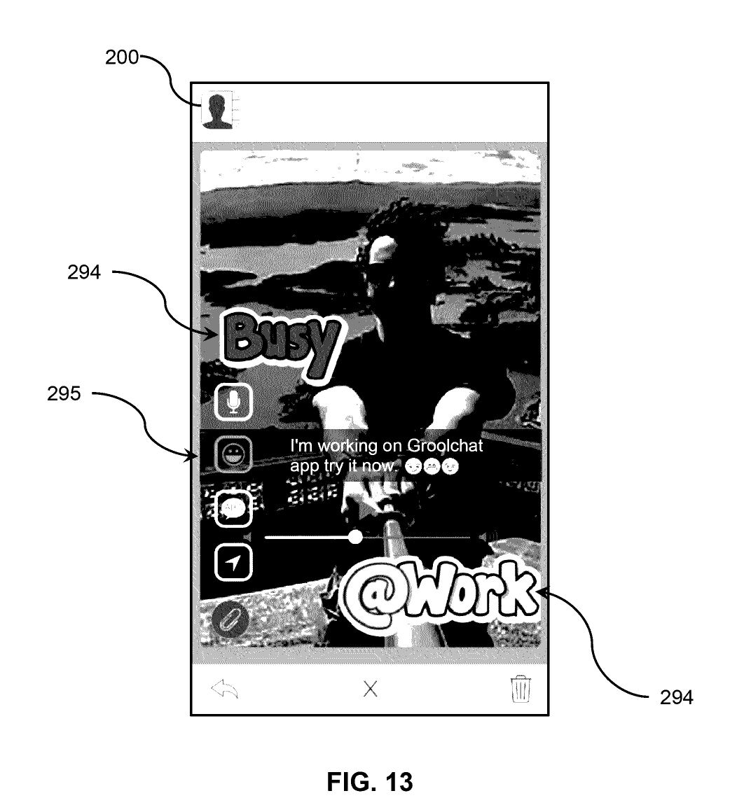

By tapping the text button 260, the user prompts a text bubble 295 and keyboard 296 to appear as shown in FIG. 12. Using the keyboard 296, the user may type one or more messages to be included as one part of the content to be sent. The one or more messages may include alphanumerical characters, glyphs, symbols, emojis, etc. As shown in FIG. 13, the one or more messages may be displayed overtop the background (i.e., overtop the photo, the video, the default background, etc.). The user may position the messages by dragging and dropping the messages at a particular location on the background.

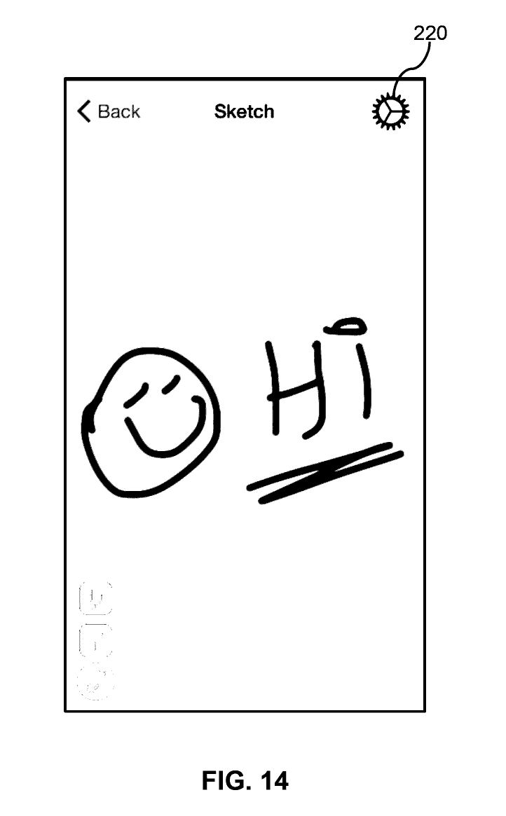

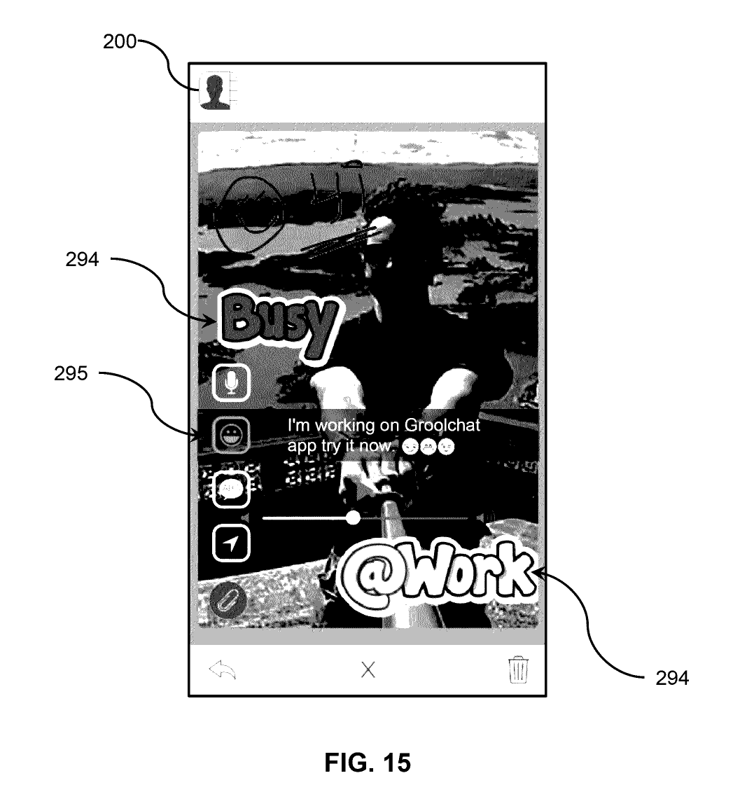

By tapping the sketch button 270, the user can access a sketch tool (sketch tool block 108). Using the sketch tool, the user may use his or her finger, a stylus pen, etc. to create one or more sketches and/or write one or more messages as one part of the content to be sent. For example, as shown in FIG. 14, the user may draw a smiley face and write “Hi” as part of the content to be sent. As shown in FIG. 15, the one or more sketches and/or the one or more messages may be displayed overtop the background (i.e., overtop the photo, the video, the default background, etc.). The user may position the one or more sketches and/or the one or more messages by dragging and dropping the one or more sketches and/or the one or more messages at a particular location on the background.

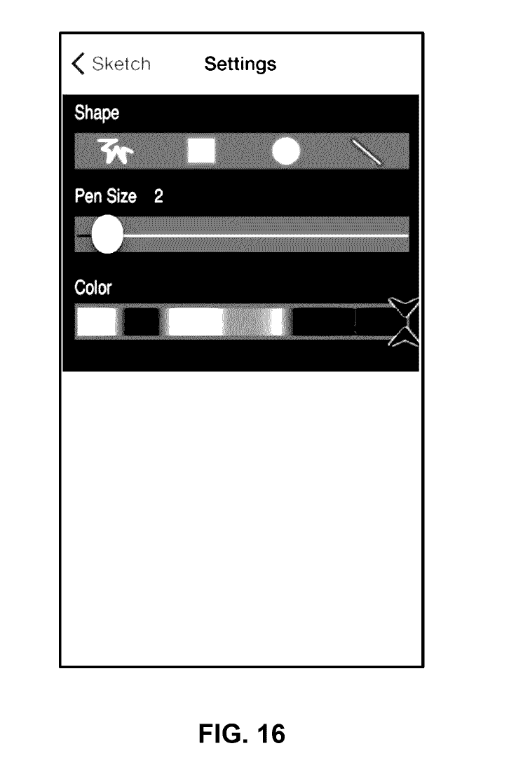

As shown in FIG. 16, by tapping the settings button 220 while using the sketch tool (i.e., while in the sketch tool block 108), the user may access a sketch-tool-specific settings screen (settings block 110). Within this sketch-tool-specific settings screen, the user may change the shape, size, and color of the sketch tool.

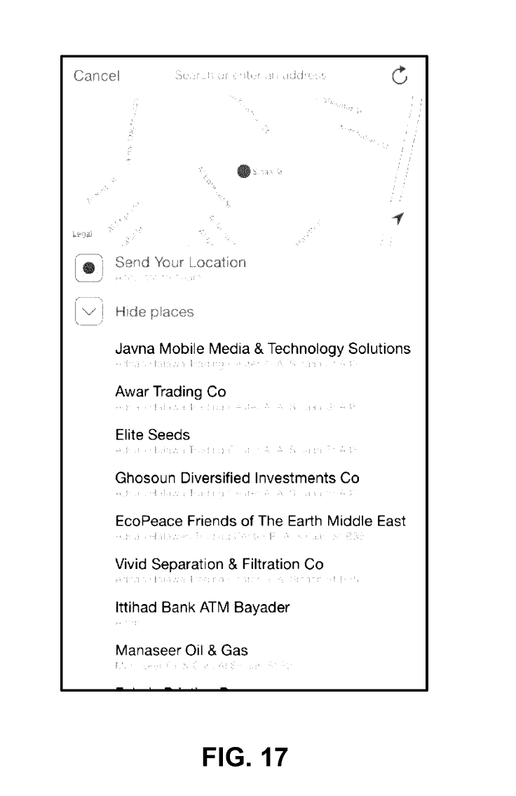

By tapping the location button 280, the user may access a mapping tool as shown in FIG. 17 (location reader block 116). Using the mapping tool, the mobile app 100 may include the user's location and/or the receiver's location as one part of the content to be sent. For example, by using Wi-Fi or GPS satellite data from the user's mobile communication device 10, the mobile app 100 may include a map, generally showing the user's location, as all or a portion of the background, and may further include a pin pointing to the specific location of the user's mobile communication device 10 (i.e., location of the user). In addition, the backend 150 may compute a distance and/or directions between the user's location and a receiver's location and append the distance and/or the directions overtop the background (i.e., overtop the photo, the video, the default background, the map, etc.) as one part of the content to be sent. It should be appreciated that the distance and/or directions may be appended with or without the map and may be included with any other background described herein (i.e., the photo, the video, the default background, etc.).

In some exemplary embodiments, the mobile app 100 may include a map generally showing the user's location, only in those instances when the user includes only his or her location as the content to be sent. In other words, if the user includes other parts (photos, videos, audio clips, digital images or icons, stickers, emojis, text messages, sketches or messages, etc.) as parts of the content to be sent, a map generally showing the user's location will not be included; instead, if the user includes other parts, the mobile app 100 may include a text message or the like to thereby communicate the user's location as opposed to including the map. This text message may be displayed overtop the background (i.e., overtop the photo, the video, the default background, etc.).

In some exemplary embodiments, the mobile app 100 may include a map generally showing the user's location, only in those instances when the user does not include photos or videos as part of the content to be sent. In other words, if the user includes photos or videos as part of the content to be sent, a map generally showing the user's location will not be included; instead, if the user includes photos or videos as part of the content to be sent, the mobile app 100 may include a text message or the like to thereby communicate the user's location as opposed to including the map. This text message may be displayed overtop the background (i.e., overtop the photo, the video, the default background, etc.).

It should be appreciated that the user may make any particular combination of parts (photos, videos, audio clips, digital images or icons, stickers, emojis, text messages, sketches or messages, locations, distances, directions, etc.) as the content to be sent. In some embodiments, each part of the content to be sent may be displayed altogether (e.g. a user's location may be displayed overtop a video, while at the same time displaying a text message, a sketch, an emoji, etc.). Alternatively, the user may elect to display particular parts for limited durations. For example, a user may choose to display a video for a limited duration (e.g., five (5) seconds), then an audio clip for another limited duration (e.g., five (5) seconds), and then finally his or her location for the remainder of the duration. In some exemplary embodiments, however, it may be appropriate to limit the combinations of parts that can be made by the user. For example, it may be desirable to limit the combinations as follows:

TABLE 1

| | | The user may also attach a . . . | | | | | | |
|---|---|---|---|---|---|---|---|---|
| | | | | Audio | Digital | Text | Sketch/ | |
| | | Video | Photo | Clip | Image/Icon | Message | Message | Location |
| If the | Video | ✓ | | | | | | ✓ |
| user | Photo | | | ✓ | ✓ | ✓ | ✓ | ✓ |
| attaches | Audio | | | ✓ | | | | ✓ |
| a . . . | Clip | | | | | | | |
| | Digital | | | ✓ | ✓ | ✓ | | ✓ |
| | Image/Icon | | | | | | | |
| | Text | | | ✓ | | ✓ | | ✓ |
| | Message | | | | | | | |
| | Sketch/ | | | ✓ | | | ✓ | ✓ |
| | Message | | | | | | | |
| | Location | | | | | | | ✓ |

Once the user has created and combined the content to be sent, the user may select a receiver from the user's contacts list (contacts block 112) by tapping the contacts button 200 thereby causing a contacts screen CS to appear. Alternatively, the user may select a receiver from the user's contacts list (contacts block 112) before or during creation and combination of the content to be sent. It should be appreciated that the user may change the receiver at any time before sending the content to be sent.

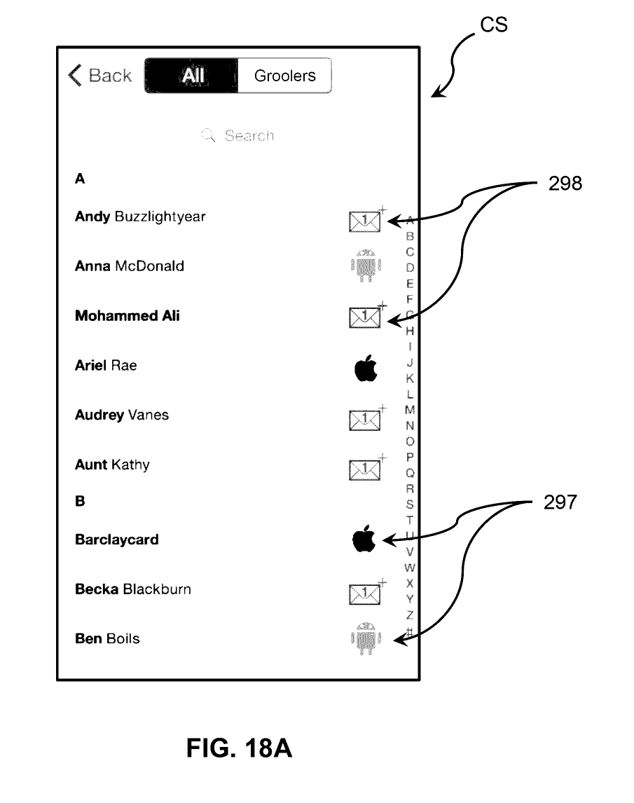

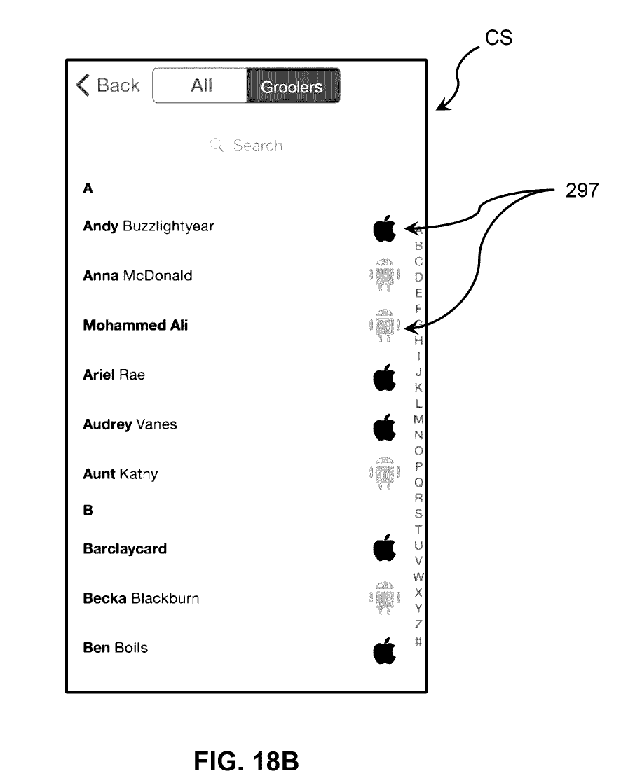

As the user is viewing his or her contacts list, the mobile app 100 may provide the user with information regarding which contacts have the mobile app 100 and/or the operating system of each contact's respective mobile communication device 10A. In this manner, the user and/or the mobile app 100 may send only those parts which are appropriate given the respective capabilities of each receiver's mobile communication device 10A. For example, as shown in FIG. 18A, the user may view all of his or her contacts. When the user is viewing all of his or her contacts, those contacts having the mobile app 100 are provided with an operating system icon 297. The operating system icon 297 represents the operating system of each contact's respective mobile communication device 10A (e.g., the Android® robot, the Apple® logo, etc.). In contrast, those contacts not having the mobile app 100 are provided with an invite icon 298. As will be described in more detail below, the user may tap the invite icon 298 to invite those contacts not having the mobile app 100 to download and install the mobile app on their respective mobile communication devices 10A. As shown in FIG. 18B, the user may view only those contacts which have the mobile app 100 (Groolchat). When the user is viewing only those contacts which have the mobile app 100, each contact is provided with an operating system icon 297.

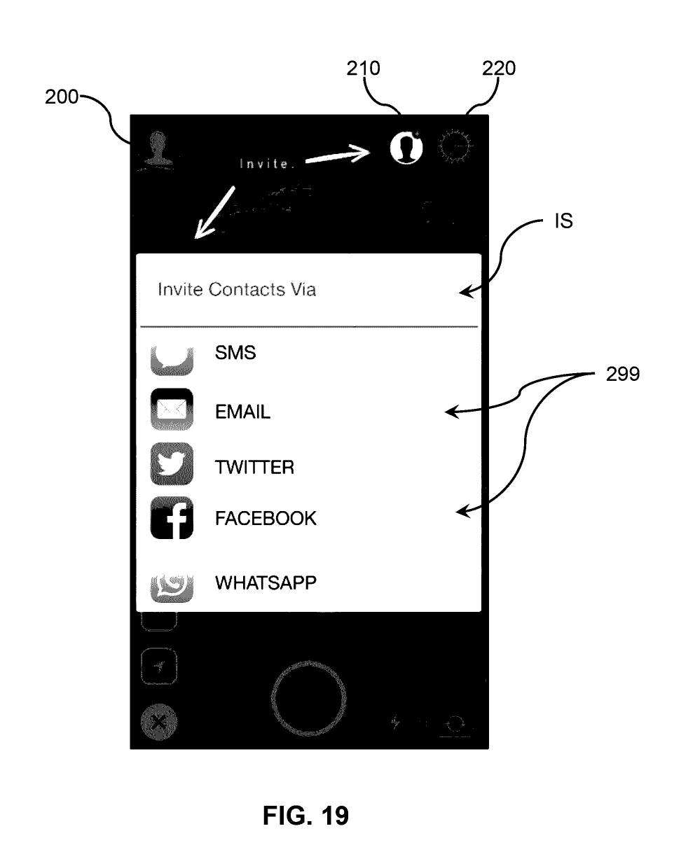

If the user realizes that contacts or other family, friends, business associates, etc. do not have the mobile app 100, the user may wish to invite them to download and install the mobile app on their respective mobile communication devices 10A. As shown in FIG. 19, the user may access an invite screen IS (invite block 114) by tapping the invite button 210 on the main screen MS or by tapping the invite icon 298 on the contacts screen CS. The invite screen IS allows the user to invite his or her contacts or other family, friends, business associates, etc. to download and install the mobile app 100 on their respective mobile communication devices 10A. In this manner, the user and his or her contacts or other family, friends, business associates, etc. may communicate via the mobile app 100. As shown in FIG. 19, the invite screen IS includes a plurality of buttons 299 which allow the user to choose a particular method by which to send the invite to his or her contacts or other family, friends, business associates, etc. For example, the user may choose to send the invite via SMS text message, email, Twitter, Facebook, or WhatsApp.

After the user has selected a receiver, the user may be prompted to specify whether the content to be sent is to appear before and/or after a voice call or voice over internet protocol (VoIP) call (hereinafter commonly referred to as a “voice call”) placed to the receiver. The user may also be prompted to specify the validity or correctness of the content to be sent. At this point, the user can make final changes to the content to be sent or may discard the content to be sent in its entirety.

Once these steps are complete, the content to be sent is sent via the wireless communication network 180 and compressed on web server 152 in the backend 150. After the content to be sent is received on the web server 152, the backend 150 will determine whether the mobile app 100 is installed on the receiver's mobile communication device 10A and whether the receiver's mobile communication device 10A is online (i.e., connected to a wireless communication network). If the mobile app 100 is installed on the receiver's mobile communication device 10A and the receiver's mobile communication device 10A is online, the content to be sent will be forwarded to the database 154, in which the content to be sent is saved temporarily (media management block 160). At this point, a notification will be created (notification management block 166) and an access token will be assigned to the receiver's mobile communication device 10A. The notification will then be sent to the receiver's mobile communication device 10A via the notification server 156 to the appropriate notification server (e.g., Google Cloud Messaging, Apple notification server, etc.) depending upon the platform of the receiver's mobile communication device 10A.

Once the notification is received on the receiver's mobile communication device 10A, the content will be downloaded onto the receiver's mobile communication device 10A and saved in a private folder not accessible by the receiver. After the content is downloaded successfully onto the receiver's mobile communication device 10A, a confirmation is sent to the database 154 via the web server 152. Once the confirmation is received, a notification will be created (notification management block 166) and an access token will be assigned to the user's mobile communication device 10. The notification will then be sent to the user's mobile communication device 10 via the notification server 156 to the appropriate notification server (e.g., Google Cloud Messaging, Apple notification server, etc.) depending upon the platform of the receiver's mobile communication device 10A.

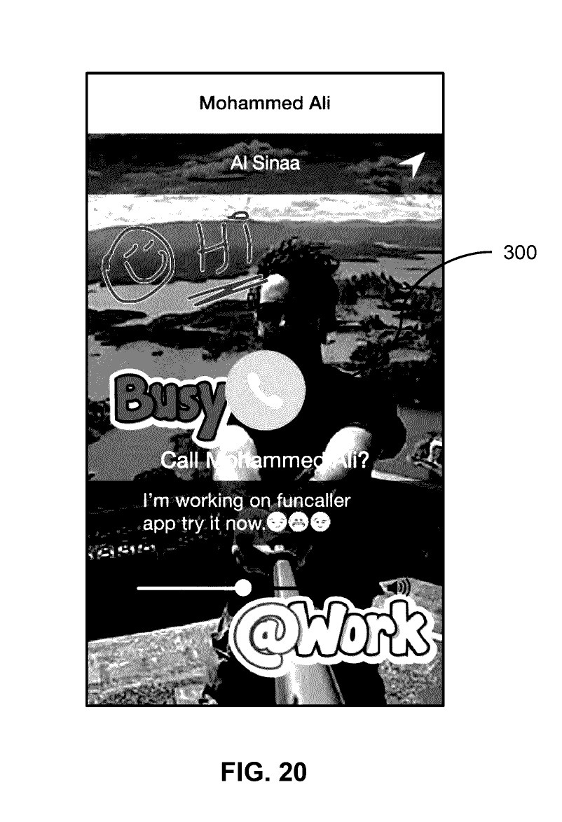

As shown in FIG. 20, once the notification is received on the user's mobile communication device 10, a message and dial icon 300 will appear on the screen of the user's mobile communication device 10 (i.e., a dial screen). The user may place a voice call to the receiver by tapping the dial icon 300. Once the receiver's mobile communication device 10A receives the voice call, the content will be displayed on the receiver's mobile communication device 10A for a predetermined duration or until the receiver answers the voice call, at which time the content will cease to be displayed on the receiver's mobile communication device 10A.

If the notification is not received by the user's mobile communication device 10 within a predetermined period of time, regardless of the reason, a timeout error may appear on the user's mobile communication device 10. This timeout error may inform the user that the requested process cannot be completed successfully and may further provide the reason for the failure. Upon receiving the timeout error, the user may be prompted to cancel the requested process, try again using the same contact (i.e., receiver), or try again using a different contact (i.e., receiver).

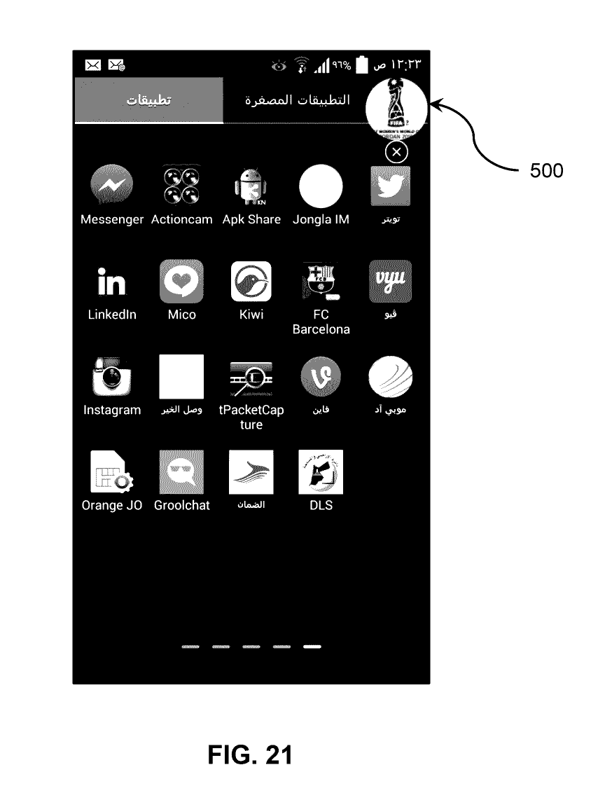

In some exemplary embodiments, if the user specifies that the content to be sent is to appear after the voice call, once the receiver ends the voice call, a floating icon 500 will appear on the receiver's mobile communication device 10A. For example, the floating icon 500 may appear overtop other apps that may be present on the receiver's mobile communication device 10A as shown in FIG. 21. If the receiver taps on the floating icon 500, the content will appear once again or for the first time for a predetermined duration or until the receiver closes the content. In such exemplary embodiments, the user may be prompted to select the area over which the floating icon 500 will be displayed or on which apps the floating icon 500 will be displayed on the screen of the receiver's mobile communication device 10A. In some exemplary embodiments, there may be a maximum number of contents pending to be viewed via tapping the floating icon 500.

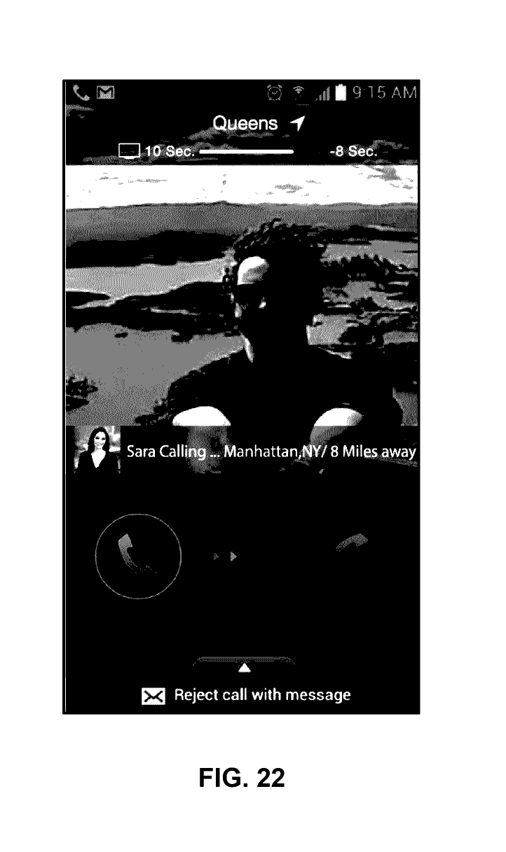

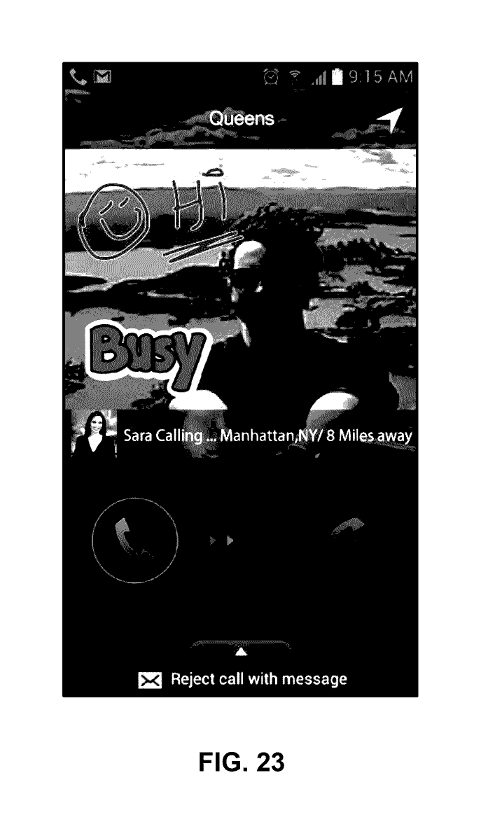

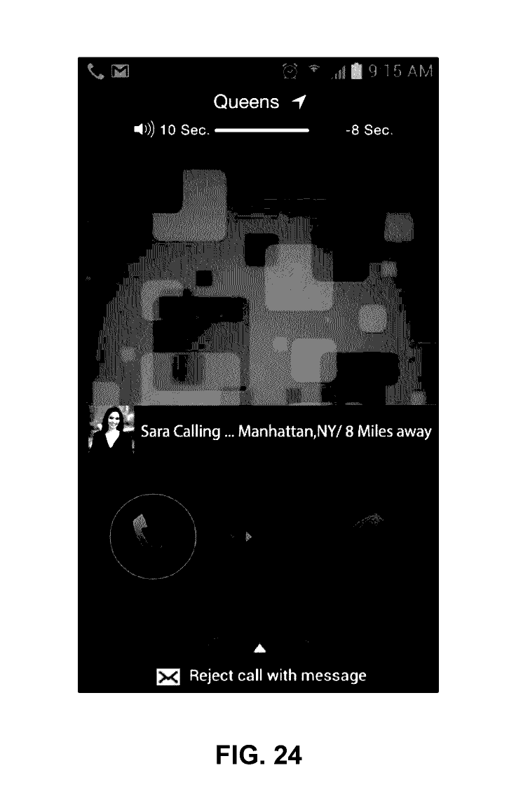

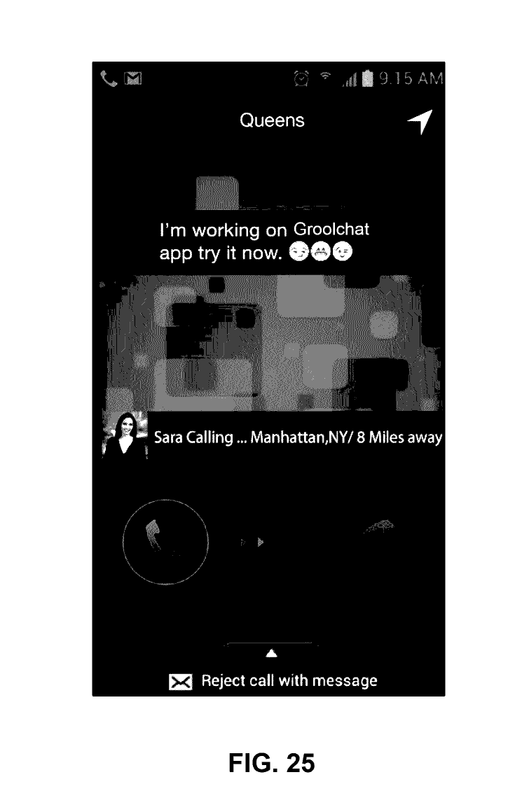

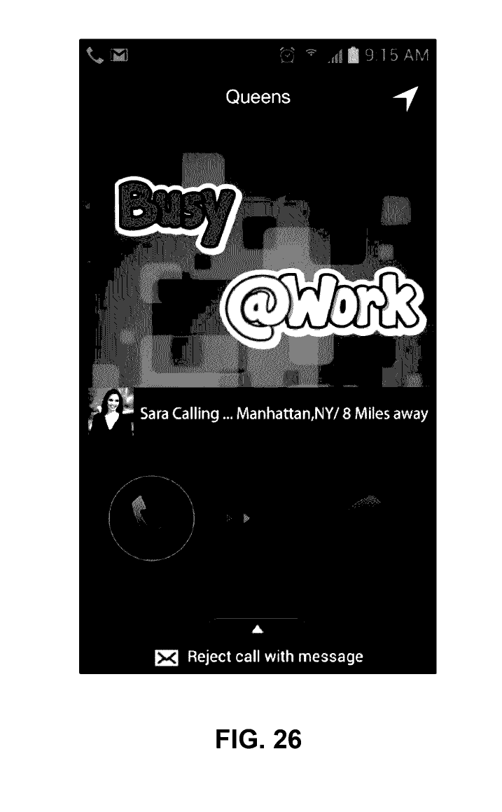

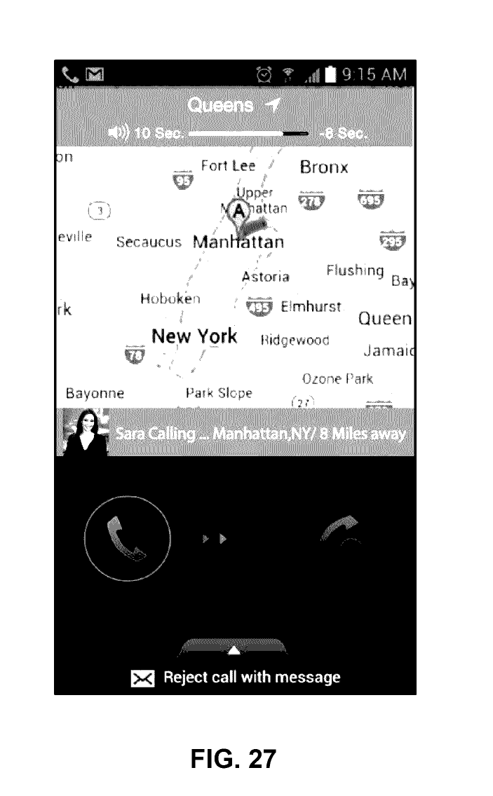

FIGS. 22-27 depict exemplary contents as displayed on the receiver's mobile communication device 10A, prior to expiration of the predetermined duration or prior to the receiver answering the voice call (i.e., during a pending voice call). For example, as shown in FIG. 22, the contents include a video, the user's location, the receiver's location, and a distance between the user and the receiver; in FIG. 23, the contents include a photo, a sketch and message, a digital image or icon, the user's location, the receiver's location, and a distance between the user and the receiver; in FIG. 24, the contents include a default background, an audio clip, the user's location, the receiver's location, and a distance between the user and the receiver; in FIG. 25, the contents include a default background, a text message, the user's location, the receiver's location, and a distance between the user and the receiver; in FIG. 26, the contents include a default background, a pair of digital images or icons, the user's location, the receiver's location, and a distance between the user and the receiver; and in FIG. 27, the contents include a map, generally showing the user's location, and a pin pointing to the specific location of the user, an audio clip (which may provide, among other things, directions to the user's location), the user's location, the receiver's location, and a distance between the user and the receiver.

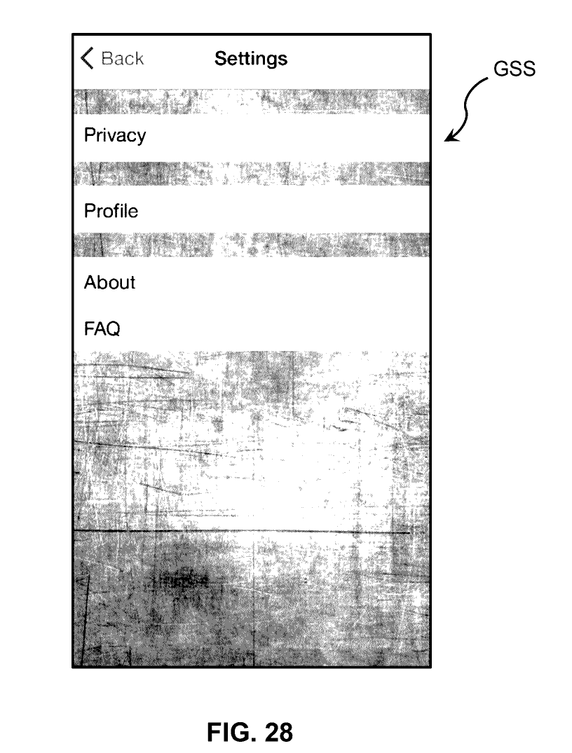

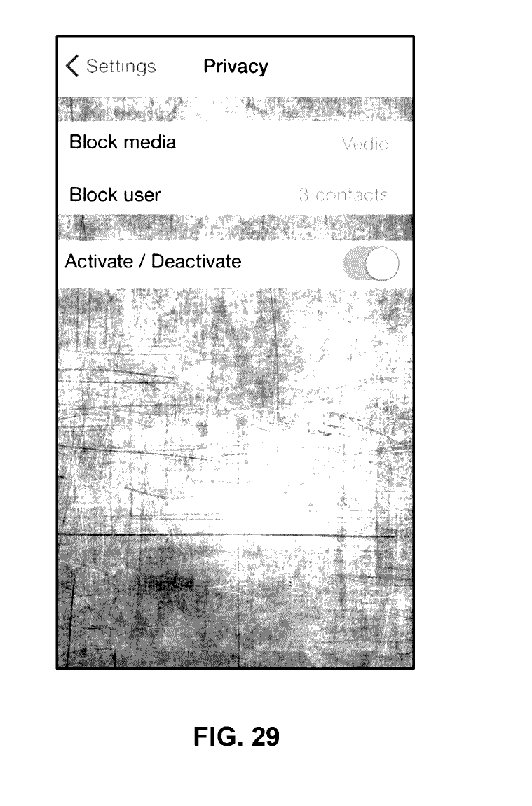

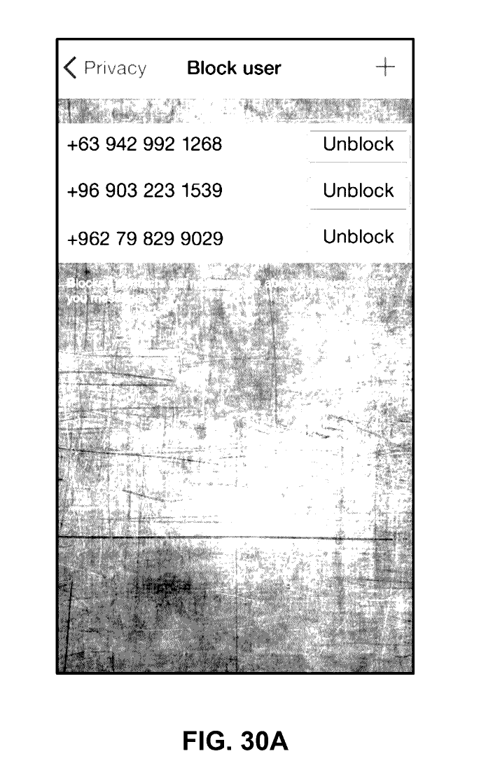

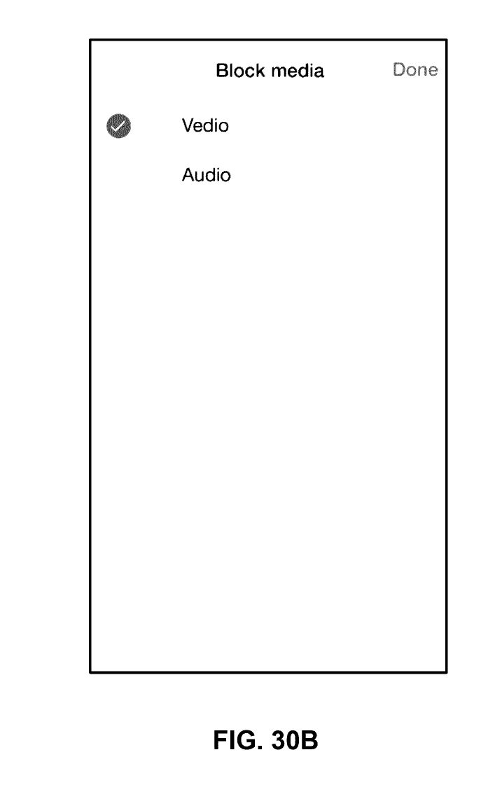

As shown in FIG. 28, by tapping the settings button 220, the user may access a general settings screen (settings block 110). Within the general settings screen, the user may change the settings of the mobile app 100. For example, the user may change his or her privacy settings (FIG. 29). In particular, as shown in FIG. 30A, the user may block one or more unwanted contacts such that the user does not receive content from these blocked contacts via the mobile app 100. Further, as shown in FIG. 30B, the user may block one or more types of media from one or more users such that the user does not receive these types of media via the mobile app 100. The user may also deactivate his or her account (FIG. 29) such that the user does not receive any content from any user via the mobile app 100 until he or she reactivates the account. The blocking management block 168 of the database 154 may save each user's blocking preferences (e.g., contacts blocked by the user, media types blocked by the user, etc.).

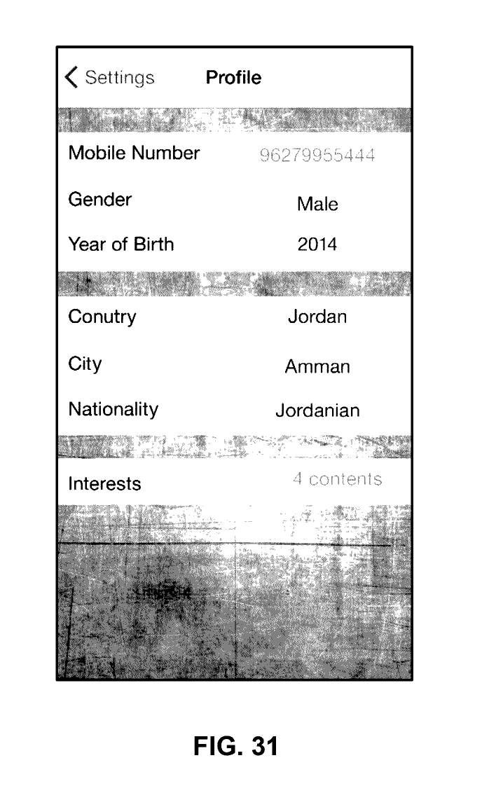

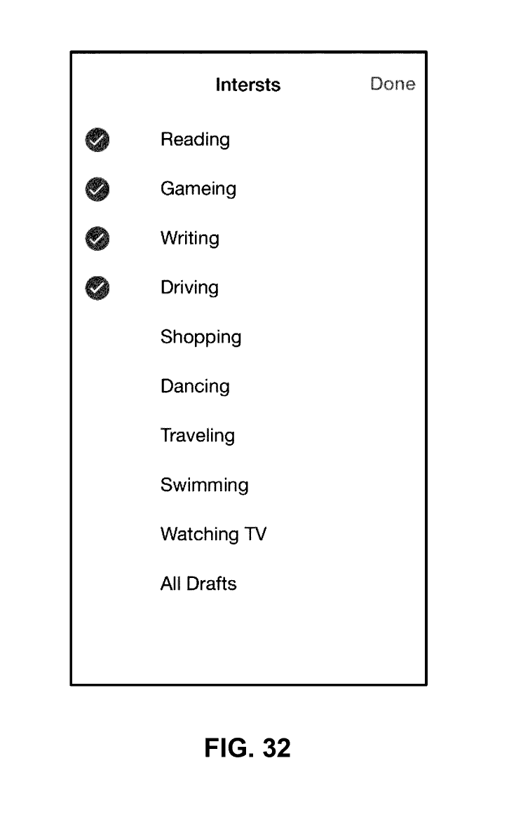

The user may also access the user profile block 106 and make changes thereto by tapping the settings button 220. For example, as shown in FIGS. 31 and 32, the user may edit his or her personal information (e.g., phone number, gender, year of birth, location, nationality, interests, etc.). The profile management block 158 of the database 154 may save the data relating to each user's profile and any updates thereto. The profile management block 158 may also detect whether a particular user is a new user of the mobile app 100 or a user that has registered before.

The contacts management block 162 of the database 154 may save each user's contacts. The contacts management block 162 may sync the data saved for each user at predetermined intervals to ensure that the data is kept up to date.

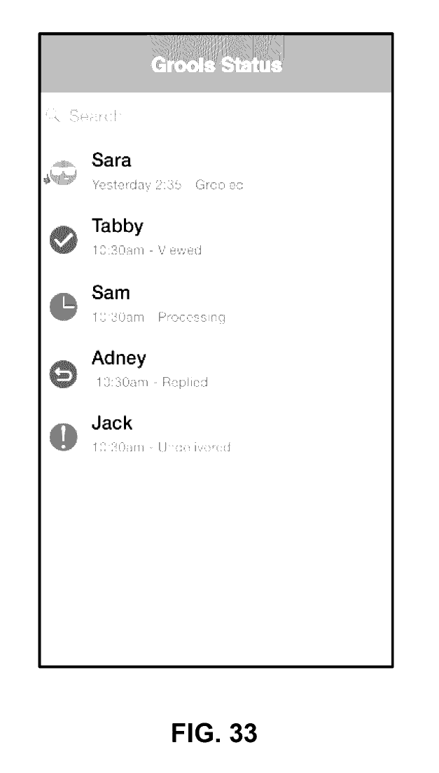

By tapping the status button 205, the user may access a status screen as shown in FIG. 33. In this screen, the user can check the status of content that has been sent. For example, the user can check to see if content has been delivered, viewed, pending/processing, undelivered/failed, etc. and also whether a particular contact has replied to the content sent.

It should be understood that any of the exemplary embodiments described herein may include various other steps and/or features in addition to or in lieu of those described above. It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the exemplary embodiments described herein may be combined will be readily apparent to those of ordinary skill in the art in view of the teachings herein. Such modifications and variations are intended to be included within the scope of the claims.

Having shown and described various exemplary embodiments of the present disclosure, further adaptations of the methods and systems described herein may be accomplished by appropriate modifications by one of ordinary skill in the art without departing from the scope of the present disclosure. Several of such potential modifications have been mentioned, and others will be apparent to those skilled in the art. Accordingly, the scope of the present disclosure should be considered in terms of the following claims and is understood not to be limited to the details of structure and operation shown and described in the specification and drawings.

What is claimed is:

1. A method of communication between a sender's mobile communication device and a receiver's mobile communication device using a mobile app, the sender's mobile communication device and the receiver's mobile communication device being connected to one another via one or more wireless communication networks, the sender's mobile communication device and the receiver's mobile communication device further being connected to a backend via the one or more wireless communication networks, the method comprising:
i. creating content on the sender's mobile communication device;
ii. sending the content to the receiver's mobile communication device;
iii. based upon the content being successfully sent to the receiver's mobile communication device, causing a dial icon to appear on the sender's mobile communication device;
iv. placing a voice call from the sender's mobile communication device to the receiver's mobile communication device by tapping the dial icon; and
v. based upon the receiver's mobile communication device receiving the voice call, displaying the content on the receiver's mobile communication device for a predetermined duration or until the receiver answers the voice call.

2. The method of claim 1, wherein the content comprises at least one of the following parts: a photo, a video, an audio clip, a digital image or icon, a sticker, an emoji, a text message, a sketch or message, and a location of the sender or of the receiver.

3. The method of claim 2, further comprising:
based upon the content comprising a photo or a video, setting the photo or the video as a background of the content, otherwise setting a default background as the background of the content.

4. The method of claim 3, further comprising:
based upon the content comprising a digital image or icon, a text message, or a sketch or message, displaying the digital image or icon, the text message, or the sketch or message overtop the background.

5. The method of claim 2, further comprising:
based upon the content comprising a location of the sender or of the receiver, causing the backend to compute at least one of a distance and directions between the sender's location and the receiver's location, wherein the content comprises at least one of the distance and the directions.

6. The method of claim 1, further comprising:
displaying the content on the receiver's mobile communication device after the voice call has ended.

7. The method of claim 6, further comprising:
causing a floating icon to appear on the receiver's mobile communication device after the voice call has ended; and
displaying the content on the receiver's mobile communication device in response to the receiver tapping the floating icon.

8. The method of claim 7, further comprising:
prompting the sender to specify the area over which the floating icon is to be displayed on the receiver's mobile communication device.

9. The method of claim 1, further comprising:
determining at least one of whether the mobile app is installed on the receiver's mobile communication device and whether the receiver's mobile communication device is online.

10. The method of claim 1, further comprising:
blocking one or more contacts such that content is not received from the one or more contacts.

11. The method of claim 1, further comprising:
blocking one or more types of media such that the one or more types of media is not received.

12. A method of communication between a sender's mobile communication device and a receiver's mobile communication device using a mobile app, the sender's mobile communication device and the receiver's mobile communication device being connected to one another via one or more wireless communication networks, the sender's mobile communication device and the receiver's mobile communication device further being connected to a backend via the one or more wireless communication networks, the method comprising:
i. creating content on the sender's mobile communication device;
ii. sending the content to the receiver's mobile communication device;
iii. based upon the content being successfully sent to the receiver's mobile communication device, causing a dial icon to appear on the sender's mobile communication device;
iv. placing a voice call from the sender's mobile communication device to the receiver's mobile communication device by tapping the dial icon; and
v. displaying the content on the receiver's mobile communication device before or after the voice call.

13. The method of claim 12, further comprising:
prompting the sender to specify whether the content is to be displayed on the receiver's mobile communication device before or after the voice call.

14. The method of claim 13, further comprising:
based upon the sender specifying that the content is to be displayed on the receiver's mobile communication after the voice call, causing a floating icon to appear on the receiver's mobile communication device after the voice call has ended; and
displaying the content on the receiver's mobile communication device in response to the receiver tapping the floating icon.

15. The method of claim 14, further comprising:
prompting the sender to specify the area over which the floating icon is to be displayed on the receiver's mobile communication device.

16. The method of claim 12, wherein the content comprises at least one of the following parts: a photo, a video, an audio clip, a digital image or icon, a sticker, an emoji, a text message, a sketch or message, and a location of the sender or of the receiver.

17. A method of communication between a sender's mobile communication device and a receiver's mobile communication device using a mobile app, the sender's mobile communication device and the receiver's mobile communication device being connected to one another via one or more wireless communication networks, the sender's mobile communication device and the receiver's mobile communication device further being connected to a backend via the one or more wireless communication networks, the method comprising:
i. creating content on the sender's mobile communication device;
ii. sending the content to the receiver's mobile communication device;
iii. based upon the content being successfully sent to the receiver's mobile communication device, causing a dial icon to appear on the sender's mobile communication device;
iv. placing a voice call from the sender's mobile communication device to the receiver's mobile communication device by tapping the dial icon;
v. based upon the receiver's mobile communication device receiving the voice call, displaying the content on the receiver's mobile communication device for a predetermined duration or until the receiver answers the voice call; and
vi. displaying the content on the receiver's mobile communication device after the voice call has ended.

18. The method of claim 17, further comprising:
causing a floating icon to appear on the receiver's mobile communication device after the voice call has ended; and
displaying the content on the receiver's mobile communication device in response to the receiver tapping the floating icon.
